(19) United States
(12) Patent Application Publication
(10) Pub. No.: US 2009/0327408 A1
(43) Pub. Date: Dec. 31, 2009

(54) MOBILE TERMINAL

(75) Inventors: Kazuhiro NAGASE, Tokyo (JP); Kiyoshi Kagenaga, Chiba-Ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/406,431

(22) Filed: Mar. 18, 2009

(30) Foreign Application Priority Data
Jun. 30, 2008 (JP) P2008-171643

(51) Int. Cl. G06F 15/16; H04L 9/32

(52) U.S. Cl. 709/203; 726/7

(57) ABSTRACT

A mobile terminal includes a storage unit, a wireless LAN communication unit, and a display unit. The storage unit stores device identification information for identifying the mobile terminal. The wireless LAN communication unit connects to a management server managing, for each mobile terminal, attribute information related to at least one content server to which the mobile terminal is connected via a network. The wireless LAN communication unit transmits the device identification information to the management server along with a request for the attribute information. Then, the wireless LAN communication unit receives one or more pieces of attribute information from the management server. The display unit displays the received one or more pieces of attribute information.

### BACKGROUND OF THE INVENTION

1. Field of the Invention

The present invention relates to a mobile terminal, and particularly to a mobile terminal such as a cellular phone capable of allowing viewing (browsing) of information managed on Web sites to which the mobile terminal is connected via a network.

2. Description of the Related Art

Recently, mobile terminals connectable to the Internet have been known. A mobile terminal of this type is capable of executing a browser application, connecting to Web sites via the Internet, and viewing (browsing) of various types of information managed on the Web sites. A user who owns the mobile terminal connectable to the Internet typically owns a personal computer at home. The user uses the personal computer, as well as the mobile terminal, to view (browse) various types of information managed on Web sites.

In recent years, mobile terminals have begun to be equipped with a special browser called “full browser”. The full browser is intended to allow viewing of not only information managed on Web sites created for services on mobile terminals such as cellular phones, but also all types of information including information managed on general Web sites on the Internet. For example, the following full browser is proposed.

To allow viewing of information managed on a Web site from a mobile terminal, a relay server between the mobile terminal and the Web site obtains and temporarily stores information such as HTML files managed on the Web site. The relay server performs high-load processing, such as rendering, on the information obtained from the Web site and transmits the resulting information to the mobile terminal. This can not only reduce communication time, but also minimize the load of browsing processing executed by the mobile terminal.

Japanese Unexamined Patent Application Publication No. 2007-213537 proposes the following technique as an example of a technique in which a mobile terminal executes a browser application to allow viewing of information managed on Web sites. In the technique proposed in this document, after a cursor pointer is displayed on a screen of a cellular phone, line feeds are automatically inserted into text such that the text is fitted to the size of the screen. Then, by pressing a determination button on the cellular phone, the text is automatically moved to a readable position. Thus, Web sites designed for personal computers can be smoothly viewed on the cellular phone.

If a mobile terminal executes a browser application and connects to Web sites via the Internet, the user often selects a desired Web site from bookmarks on the browser application to connect to the desired Web site. The same connecting method applies to the case of a home personal computer owned by the user. If the user alternately uses the mobile terminal and the personal computer to connect to Web sites, the Web sites accessed from the mobile terminal and the personal computer often overlap. In this case, the user has to register desired Web sites as bookmarks, separately on both the mobile terminal and the personal computer.

However, as described above, if information managed on a Web site is viewed via a relay server, bookmark information about a desired Web site accessed from the mobile terminal is typically managed by the relay server or a dedicated management server. Therefore, if bookmark information on the personal computer is registered on the relay server, it is possible to synchronize the bookmark information between the mobile terminal and the personal computer.

However, to allow use of bookmark information managed by the relay server or dedicated management server, it is necessary, for protection of personal information, to verify whether users who own the mobile terminal and personal computer connected to the relay server or dedicated management server are the same person. Therefore, to allow connection to the relay server or dedicated management server from both the mobile terminal and the personal computer, it is possible to ask the user to use the same ID and password to log into either of the mobile terminal and the personal computer. This makes it possible to verify that the users of the mobile terminal and the personal computer are the same person. However, this increases the number of user actions on the mobile terminal or the personal computer, and thus causes inconvenience in connecting to Web sites.

If the user uses a portal site to frequently connect to various Web sites from the mobile terminal, the user may save URLs and names of accessed Web sites to efficiently use various types of information managed on the Web sites. However, this still causes inconvenience to the user in connecting to Web sites.

### SUMMARY OF THE INVENTION

The present invention has been made in view of the circumstances described above. One of the present invention provides a mobile terminal capable of providing improved convenience in connecting to Web sites. In particular, the present invention provides a mobile terminal capable of suitably managing a user ID for the mobile terminal. Additionally, the present invention provides a mobile terminal capable of providing improved convenience in frequently connecting to various Web sites.

To solve the problems described above, a mobile terminal according to an aspect of the present invention, the mobile terminal being capable of connecting a destination terminal via a network and being capable of connecting to a management server managing attribute information related to at least one the destination terminal, includes: a storage unit configured to store device identification information for identifying the mobile terminal; a first connecting unit configured to connect to the management server; a transmitting unit configured to transmit, to the management server, the device identification information and a request signal for obtaining the attribute information; a receiving unit configured to receive the attribute information from the management server; and a display unit configured to display data based on the attribute information received by the receiving unity. To solve the problems described above, a mobile terminal according to another aspect of the present invention, the mobile terminal being capable of connecting a destination terminal via a network, includes: a storage unit configured to store image data obtained from at least one the destination terminal, information related to a date and time of connection to the destination terminal, and attribute information related to the destination terminal; and a display unit configured to display indication information in a display area on a screen displaying a list of dates, the indication information indicating that the image data, the information related to the date and time of connection to the destination terminal, and the attribute information are stored by the storage unit, the display area corresponding to the stored date and time of connection to the destination terminal. includes a storage unit configured to store image data obtained from at least one destination to which the mobile terminal is connected via a network, information related to a date and time of connection to the destination, and attribute information related to the destination; and a display unit configured to display indication information in a display area on a screen displaying a list of dates, the indication information indicating that the image data, the information related to the date and time of connection to the destination, and the attribute information are stored by the storage unit, the display area corresponding to the stored date and time of connection to the destination.

The present invention improves convenience in connecting to Web sites.

### BRIEF DESCRIPTION OF THE DRAWINGS

FIG. 1 illustrates a schematic configuration of a network system according to an embodiment of the present invention.

FIG. 2 is a block diagram illustrating an internal configuration of a mobile terminal according to an embodiment of the present invention.

FIG. 3 is a flowchart illustrating an overview of a use registration process executed between the mobile terminal of FIG. 2 and a management server of FIG. 1 before use of bookmark information managed by the management server.

FIG. 4 is a flowchart illustrating a use registration process in the mobile terminal of FIG. 2.

FIG. 5 illustrates an example of a use registration response screen displayed on a display unit of the mobile terminal of FIG. 2.

FIG. 6 is a flowchart illustrating a use registration process in the management server of FIG. 1.

FIG. 7 illustrates a configuration of a user ID management table stored in a storage unit of the management server of FIG. 1.

FIG. 8 is a flowchart illustrating an overview of a bookmark information viewing process executed between the mobile terminal of FIG. 2 and the management server of FIG. 1.

FIG. 9 is a flowchart illustrating a bookmark information viewing process in the mobile terminal of FIG. 2.

FIG. 10 illustrates an example of bookmark information displayed on the display unit of the mobile terminal of FIG. 2.

FIG. 11 is a flowchart illustrating a bookmark information viewing process in the management server of FIG. 1.

FIG. 12 is a flowchart illustrating an overview of a bookmark information adding/editing process executed between the mobile terminal of FIG. 2 and the management server of FIG. 1, or between the management server of FIG. 1 and a personal computer of FIG. 1.

FIG. 13 is a flowchart illustrating a bookmark information adding/editing process in the mobile terminal of FIG. 2.

FIG. 14 illustrates an example of adding/editing information for bookmark information.

FIG. 15 is a flowchart illustrating a bookmark information adding/editing process in the management server of FIG. 1.

FIG. 16 illustrates a configuration of a user ID management table stored in the storage unit of the management server of FIG. 1.

FIG. 17 is a flowchart illustrating a bookmark information adding/editing process in the personal computer of FIG. 1.

FIG. 18 is a flowchart illustrating a bookmark information adding/editing process in the management server of FIG. 1.

FIG. 19 is a flowchart illustrating a page memo storage process in the mobile terminal of FIG. 2.

FIG. 20 illustrates an example of a display screen displayed on the display unit of the mobile terminal of FIG. 2.

FIG. 21 is a flowchart illustrating a page memo call process in the mobile terminal of FIG. 2.

FIG. 22 is a transition diagram illustrating transition of a display screen on the display unit of the mobile terminal of FIG. 2.

FIG. 23 is an enlarged view of a display screen on the display unit of the mobile terminal of FIG. 2.

FIG. 24 is an enlarged view of a display screen on the display unit of the mobile terminal of FIG. 2.

FIG. 25 is an enlarged view of a display screen on the display unit of the mobile terminal of FIG. 2.

FIG. 26 is a flowchart illustrating a page memo deletion process in the mobile terminal of FIG. 2.

### DESCRIPTION OF THE PREFERRED EMBODIMENTS

Hereinafter, embodiments of the present invention will be described with reference to the drawings.

### First Embodiment

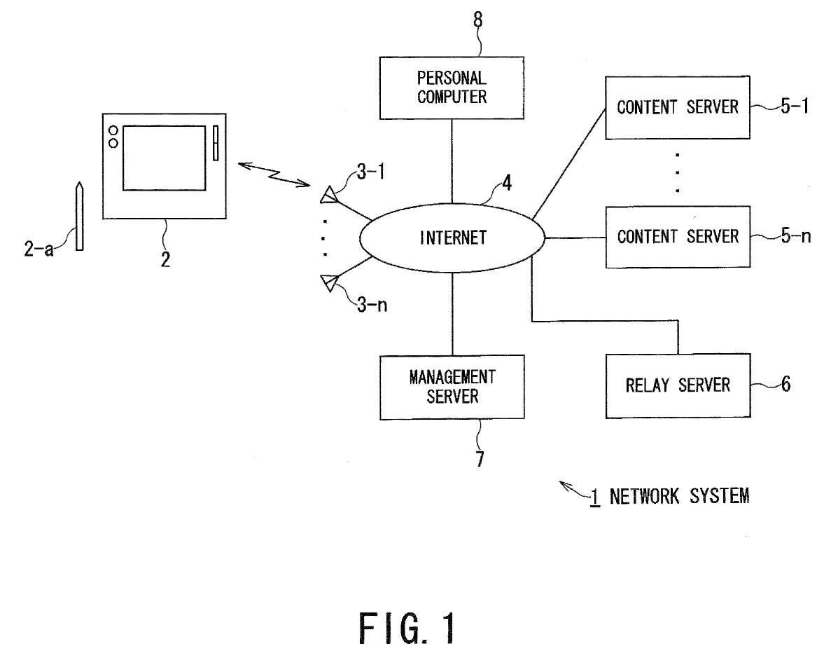

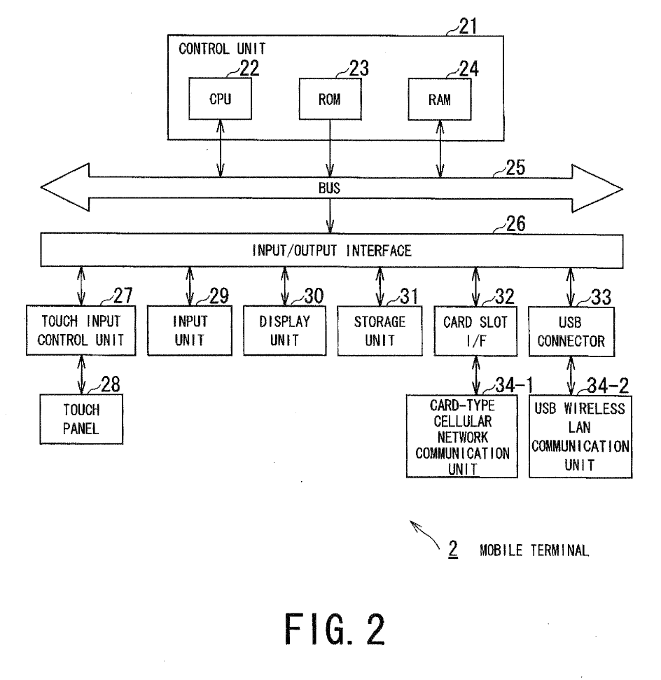

FIG. 1 illustrates a schematic configuration of a network system according to an embodiment of the present invention. As illustrated in FIG. 1, a network system 1 has access points 3-1 to 3-n serving as fixed radio stations. A mobile terminal 2 serving as a mobile radio station includes a communication unit (wireless LAN communication unit of FIG. 2) serving as a connecting unit. The mobile terminal 2 is wirelessly connected to the access points 3-1 to 3-n by the communication unit via wireless LAN communication. The mobile terminal 2 has a stylus pen 2-a serving as a pointing device.

The access points 3-1 to 3-n are connected to the Internet 4, which is the Internet network open to the public. Content servers 5-1 to 5-n managing various Web sites are connected to the Internet 4 by wired connections. To allow a user to view, from the mobile terminal 2, information on Web sites managed by the content servers 5-1 to 5-n, a relay server 6 is provided between the mobile terminal 2 and the content servers 5-1 to 5-n. The relay server 6 interprets data important for page display, the data being included in pieces of HTML information obtained from a Web site. The relay server 6 obtains image information and performs data compression and high-load processing such as a rendering processing on the obtained data. The relay server 6 transmits the resulting data to the mobile terminal 2 via the Internet 4 or another network, if needed.

A management server 7 is connected to the Internet 4 or to the relay server 6 by a wired connection. The management server 7 manages bookmark information (e.g., names and URLs of Web sites) about desired Web sites accessed from the mobile terminal 2. A home personal computer 8 owned by the user is connected to the Internet 4 by a wired or wireless connection.

FIG. 2 illustrates an internal configuration of the mobile terminal 2 according to an embodiment of the present invention. As illustrated in FIG. 2, a control unit 21 includes a central processing unit (CPU) 22, a read only memory (ROM) 23, and a random access memory (RAM) 24. The CPU 22 executes various types of processing in accordance with programs stored in the ROM 23, or various application programs including an operating system (OS), loaded from the storage unit 31 to the RAM 24. Additionally, the CPU 22 generates various control signals to be supplied to various units, and thus performs overall control of the mobile terminal 2. The RAM 24 stores data necessary for the CPU 22 to execute various types of processing.

The CPU 22, the ROM 23, and the RAM 24 are connected to one another via a bus 25. An input/output interface 26 is connected to the bus 25. An input unit 29 including operation keys, a display unit 30 such as a liquid crystal display (LCD) or an organic EL display, and the storage unit 31 including a hard disk and a non-volatile memory are connected to the input/output interface 26. A device unique ID assigned in advance to the mobile terminal 2 is stored in the storage unit 31. The device unique ID contains a serial number or MAC address of the mobile terminal 2. The display unit 30 is covered with a transparent touch panel 28.

A touch input control unit 27 is connected to the input/output interface 26. If the user performs touch input on the touch panel 28 using the stylus pen 2-a, the touch input control unit 27 detects coordinates indicating the position of the touch input. Coordinates detected by the touch input control unit 17 are represented by two axes, X and Y. The touch input control unit 17 generates a coordinate detection signal and outputs the coordinate detection signal to the control unit 21. The coordinate detection signal contains a coordinate value represented by two axes, X and Y. Thus, the mobile terminal 2 can input from the touch panel 28.

A card slot I/F 32 serving as a card slot and a USB connector 33 connectable via USB are connected to the input/output interface 26. A card-type cellular network communication unit 34-1 is connected to the card slot I/P 32. The card-type cellular network communication unit 34-1 is connected to the Internet 4 via an internal antenna and a base station that meets a standard such as a PHS standard.

A USB wireless LAN communication unit 34-2 serving as an enhancement module is connected to the USB connector 33. Like the card-type cellular network communication unit 34-1, the USB wireless LAN communication unit 34-2 performs wireless LAN communication that meets a predetermined standard such as IEEE802.11a/b/g, via the internal antenna. The USB connector 33 and the USB wireless LAN communication unit 34-2 are not limited to this type, but may be of card type or built-in type capable of performing wireless LAN communication.

Hereinafter, unless otherwise stated, any operations that involve connection to the Internet 4 via wireless LAN communication or cellular network communication are collectively referred to as operations performed by “communication unit 34”.

If the mobile terminal 2 is carried and moved by the user, the communication unit 34 of the mobile terminal 2 communicates with one of the access points 3-1 to 3-n, the one being close to the mobile terminal 2. Then, the communication unit 34 obtains an IP address newly assigned to the mobile terminal 2. The newest IP address is stored (held) in the storage unit 31 of the mobile terminal 2. Thus, the IP address of the mobile terminal 2 can be dynamically changed.

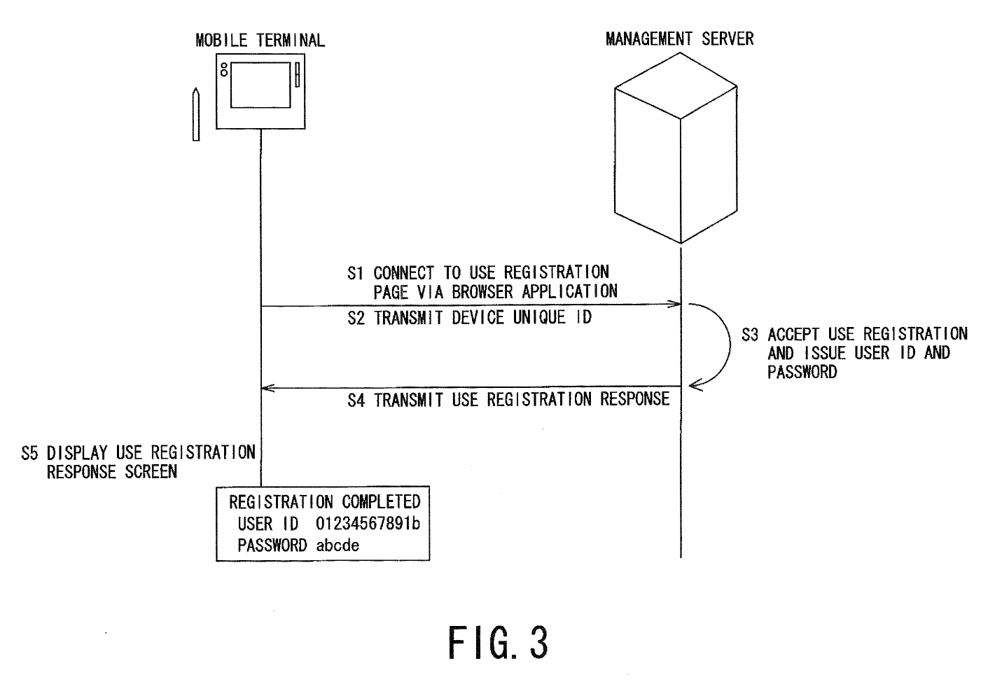

With reference to the flowchart of FIG. 3, an overview of a use registration process executed between the mobile terminal 2 (see FIG. 2) and the management server 7 (see FIG. 1) before use of bookmark information managed by the management server 7 will be described. Details of the use registration process executed between the mobile terminal 2 and the management server 7 will be described later for each device.

In step S1, the mobile terminal 2 executes a browser application to connect to a use registration page on a Web site managed by the management server 7, via an access point 3 (i.e., one of the access points 3-1 to 3-n) and the Internet 4. In step S2, the mobile terminal 2 transmits a device unique ID (e.g., a serial number or MAC address) stored in advance in the storage unit 31 to the management server 7 via the Internet 4. The device unique ID is defined as “device identification information”.

In step S3, the management server 7 receives the device unique ID transmitted from the mobile terminal 2, and accepts the use registration by using the received device unique ID of the mobile terminal 2. At the same time, the management server 7 issues (generates) a user ID and a password to the mobile terminal 2 (i.e., the user who owns the mobile terminal 2). In step S4, the management server 7 transmits a use registration response, containing the issued user ID and password, to the mobile terminal 2 via the Internet 4. In step S5, the mobile terminal 2 receives the use registration response transmitted from the management server 7. In accordance with the received use registration response, the mobile terminal 2 displays a use registration response screen. Along with a message indicating completion of the use registration, the user ID and password assigned to the mobile terminal 2 (i.e., the user who owns the mobile terminal 2) are displayed on the use registration response screen. The user ID is defined as “user identification information”, while the password is defined as “authentication information”.

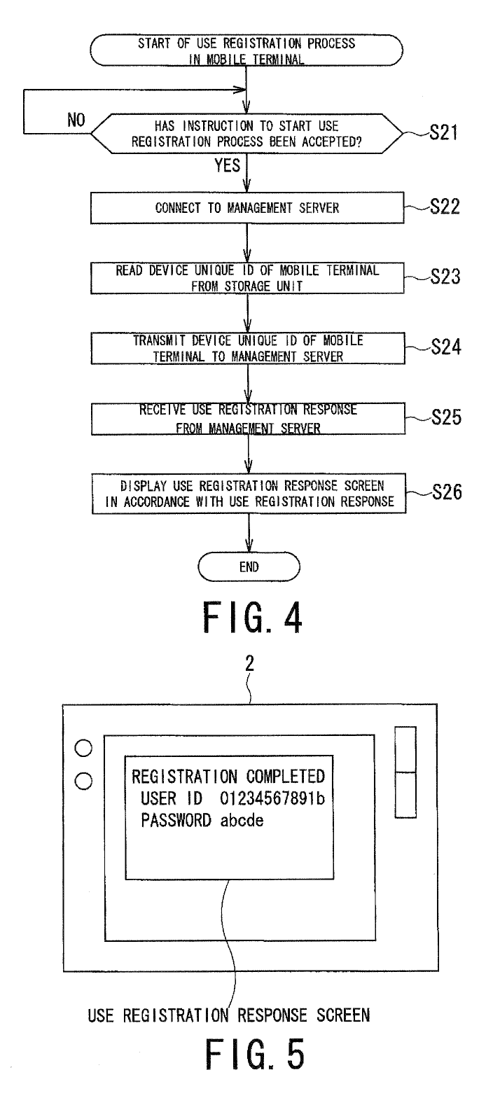

With reference to the flowchart of FIG. 4, a use registration process in the mobile terminal 2 (see FIG. 2) will be described in detail. An icon α for connection to the management server 7 is displayed on the touch panel 28 of the mobile terminal 2 as one of icons representing various functions.

In step S21, the CPU 22 of the control unit 21 determines whether an instruction to start the use registration process has been accepted, the instruction being made by the user by tapping the icon α on the touch panel 28 with the stylus pen 2-a. The CPU 22 waits until it determines that the instruction to start the use registration process has been accepted. If the CPU 22 determines in step S21 that the instruction to start the use registration process has been accepted, the process proceeds to step S22. In step S22, the CPU 22 starts the browser application, and connects to the management server 7 via the access point 3 and the Internet 4 on the basis of the URL of the management server 7.

In step S23, the CPU 22 reads out a device unique ID (e.g., a serial number or MAC address) uniquely assigned to the mobile terminal 2 and stored in advance in the storage unit 31. In the present embodiment, a MAC address (01-23-45-67-89-1b) is used as the device unique ID of the mobile terminal 2. However, the device unique ID of the mobile terminal 2 is not limited to this.

In step S24, the CPU 22 uses the read-out device unique ID of the mobile terminal 2 to set the device unique ID as part of an environment parameter (x-internetterm-subnum=01234567891b) for connection to a use registration page on a Web site managed by the management server 7. The CPU 22 controls the communication unit 34 connected to either of the card slot I/F 32 and the USB connector 33, and transmits the read-out device unique ID of the mobile terminal 2 as an environment parameter to the management server 7 via the Internet 4. Thus, the management server 7 can identify the connected mobile terminal 2 by the device unique ID.

In step S25, the communication unit 34 receives a use registration response from the management server 7 via the Internet 4. The communication unit 34 supplies the received use registration response to the CPU 22 via the input/output interface 26 and the bus 25. The CPU 22 obtains the use registration response supplied from the communication unit 34. In step S26, in accordance with the obtained use registration response, the CPU 22 controls the display unit 30 to display a use registration response screen. In accordance with control of the CPU 22, the display unit 30 displays a use registration response screen, such as that illustrated in FIG. 5. Along with a message indicating completion of the use registration, a user ID (e.g., an ID, 01234567891b, corresponding to the device unique ID of the mobile terminal 2) and password (e.g., abcde) assigned to the mobile terminal 2 (i.e., the user who owns the mobile terminal 2) are displayed on the use registration response screen. The user needs to make a note of the user ID and password, as they are used to connect to the management server 7 from the personal computer 8.

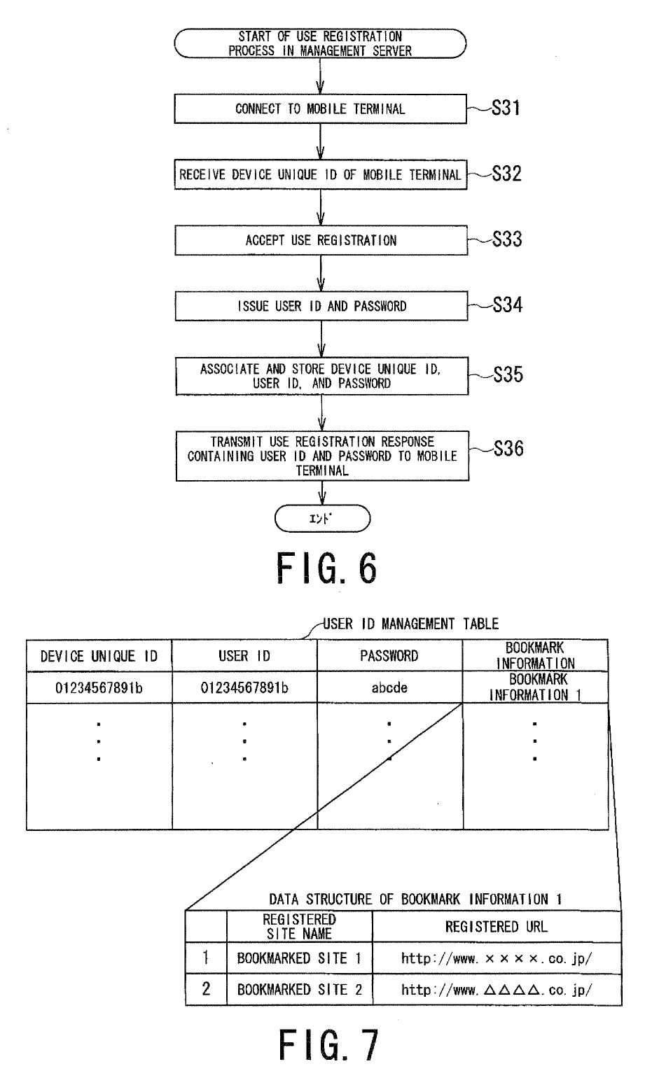

With reference to the flowchart of FIG. 6, a use registration process performed in the management server 7 (see FIG. 1), which is corresponding to the use registration process (see FIG. 4) in the mobile terminal 2, will be described in detail. The management server 7 has a CPU, a ROM, a RAM, a bus, an input/output interface, an input unit, an output unit, a storage unit and a communication unit. In step S31, upon obtaining a connection request from the mobile terminal 2 via a communication unit, the CPU of the management server 7 controls the communication unit to establish a connection between the management server 7 and the mobile terminal 2 via the Internet 4. In step S32, the communication unit receives the device unique ID transmitted as an environment parameter from the mobile terminal 2. The communication unit supplies the received device unique ID to the CPU via an input/output interface and a bus of the management server 7.

In step S33, upon obtaining the device unique ID supplied from the communication unit, the CPU accepts the use registration of the mobile terminal 2 (i.e., the user who owns the mobile terminal 2). In step S34, the CPU issues (generates) a user ID and a password to the mobile terminal 2 for which the use registration has been accepted. The user ID is a number for identifying the user who owns the mobile terminal 2, while the password is for verifying that the user is an authorized user. For example, 01234567891b corresponding to the device unique ID of the mobile terminal 2 may be issued as a user ID, while abcde may be issued as a password. In step S35, the CPU associates the device unique ID of the mobile terminal 2 with the user ID and password, and stores the device unique ID, the user ID and password in a user ID management table in a storage unit.

FIG. 7 illustrates a configuration of the user ID management table stored in the storage unit of the management server 7 (see FIG. 1). As illustrated in FIG. 7, the device unique ID, user ID, and password of the mobile terminal 2 are associated and registered.

In step S36 of FIG. 6, the CPU controls the communication unit to transmit a use registration response, containing the issued user ID and password, to the mobile terminal 2 via the Internet 4.

Then, bookmark information desired by the user is registered in the management server 7 from the mobile terminal 2 or the personal computer 8, and stored in the user ID management table in the storage unit. For example, bookmark information 1 stored in the user ID management table shown in FIG. 7 contains “bookmarked site 1” and “http://www.xxxx.co.jp” associated with each other, and “bookmarked site 2” and “http://www.ΔΔΔΔ.co.jp” associated with each other. Information managed for each mobile terminal 2 in the management server 7 is not limited to the bookmark information described above. Various types of user-specific information, such as a history of destinations and information about a page currently being viewed, may be managed by the management server 7. Site-related information, such as bookmark information and history information, is defined as “attribute information related to a destination”.

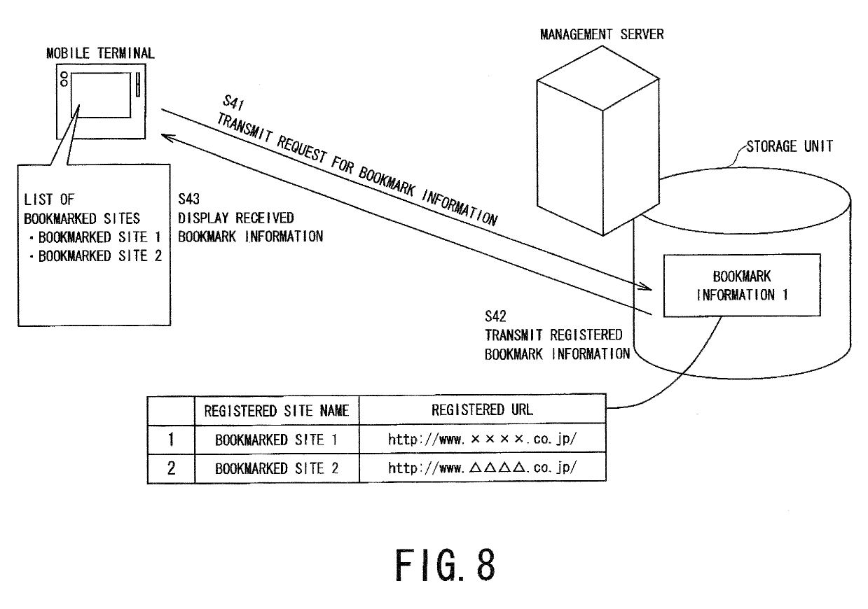

With reference to the flowchart of FIG. 8, an overview of a bookmark information, viewing process executed between the mobile terminal 2 (see FIG. 2) and the management server 7 (see FIG. 1) will be described. Details of the bookmark information viewing process executed between the mobile terminal 2 and the management server 7 will be described later for each device.

In step S41, the mobile terminal 2 executes the browser application to connect to the management server 7 via the access point 3 and the Internet 4. The mobile terminal 2 adds a device unique ID (e.g., a serial number or MAC address) stored in advance in the storage unit 31 to a request signal for obtaining user's bookmark information managed by the management server 7. Then the mobile terminal 2 transmits, to the management server 7 via the Internet 4, the bookmark information request and the device unique ID added thereto.

In step S42, the management server 7 receives the bookmark information request signal transmitted from the mobile terminal 2. The management server 7 uses the device unique ID of the mobile terminal 2, the device unique ID being added to the received bookmark information request signal, to identify the mobile terminal 2 (i.e., the user who owns the mobile terminal 2) having requested the bookmark information. The management server 7 then transmits registered bookmark information associated with the identified mobile terminal 2 to the mobile terminal 2 via the Internet 4. The registered bookmark information contains the name and URL of a bookmarked site registered in advance, the name and URL being associated with each other. In step S43, the mobile terminal 2 receives the bookmark information transmitted from the management server 7 and displays the received bookmark information.

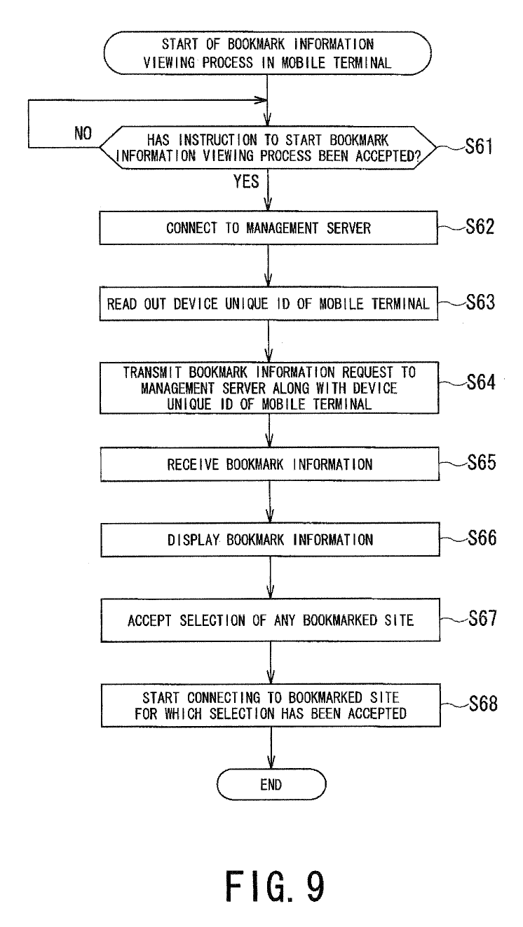

With reference to the flowchart of FIG. 9, a bookmark information viewing process in the mobile terminal 2 (see FIG. 2) will be described in detail. In step S61, the CPU 22 of the control unit 21 determines whether an instruction to start the bookmark information viewing process has been accepted, the instruction being made by the user by tapping the icon α on the touch panel 28 with the stylus pen 2-a. The CPU 22 waits until it determines that the instruction to start the bookmark information viewing process has been accepted. If the CPU 22 determines in step S21 that the instruction to start the bookmark information viewing process has been accepted, the process proceeds to step S62. In step S62, the CPU 22 executes the browser application, and connects to the management server 7 via the access point 3 and the Internet 4 on the basis of the URL of the management server 7.

In step S63, the CPU 22 reads out the device unique ID uniquely assigned to the mobile terminal 2 and stored in advance in the storage unit 31. In step S64, the CPU 22 generates a bookmark information request signal for obtaining bookmark information managed for each user (mobile terminal 2,) by the management server 7. Then, the CPU 22 controls the communication unit 34 to transmit the generated bookmark information request signal to the management server 7 via the Internet 4, along with the device unique ID of the mobile terminal 2. The bookmark information request signal is defined as “attribute information request signal”.

In step S65, the communication unit 34 receives bookmark information transmitted from the management server 7 via the Internet 4. The communication unit 34 supplies the received bookmark information to the CPU 22 via the input/output interface 26 and the bus 25. The bookmark information contains the registered sits name and registered URL associated with each other. For example, bookmark information 1 shown in FIG. 8 contains “bookmarked site 1” and “http://www.xxxx.co.jp” associated with each other, and “bookmarked site 2” and “http://www.ΔΔΔΔ.co.jp” associated with each other.

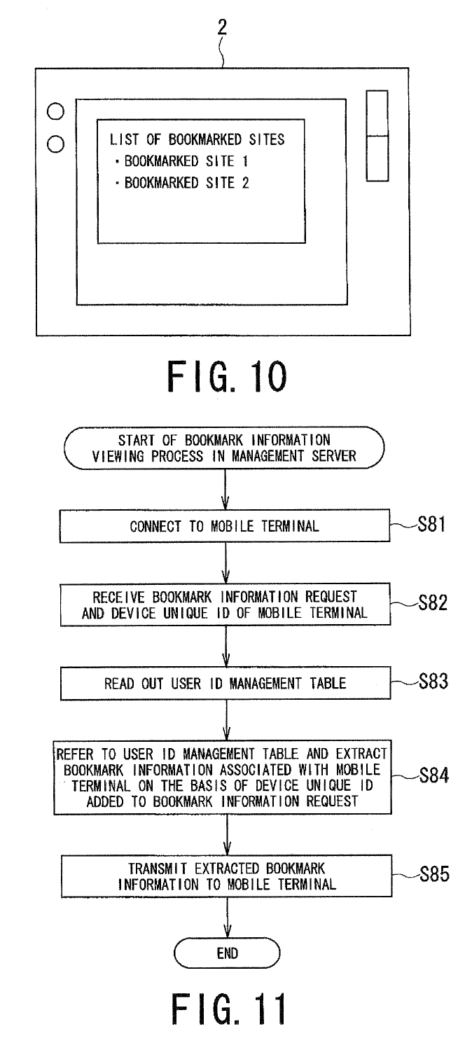

In step S66, the CPU 22 obtains the bookmark information supplied from the communication unit 34, and controls the display unit 30 to display the obtained bookmark information. In accordance with control of the CPU 22, the display unit 30 displays the bookmark information, such as that illustrated in FIG. 10. As illustrated in FIG. 10, the display unit 30 displays “bookmarked site 1” and “bookmarked site 2”. Thus, the user can easily obtain, from the management server 7, a URL of a site to which the user wants to connect. Then, the user operates the mobile terminal 2 to start a connection process based on this URL.

In step S67, the CPU 22 accepts selection of any one of bookmarked sites on the touch panel 28, the selection being made by the user with the stylus pen 2-a. In step S68, the CPU 22 controls the communication unit 34 to start the connection process for connecting to a content server 5 (i.e., one of the content servers 5-1 to 5-n) via the Internet 4 by using a URL corresponding to the bookmarked site for which the selection has been accepted in step S67.

With reference to the flowchart of FIG. 11, a bookmark information viewing process performed in the management server 7 (see FIG. 1), which is corresponding to the bookmark information viewing process (see FIG. 9) in the mobile terminal 2, will be described in detail. In step S81, upon obtaining a connection request from the mobile terminal 2 via the communication unit, the CPU of the management server 7 controls the communication unit to establish a connection between the management server 7 and the mobile terminal 2 via the Internet 4. In step S82, the communication unit receives, from the mobile terminal 2, a bookmark information request signal and the device unique ID added thereto. The communication unit supplies the received bookmark information request signal and device unique ID to the CPU via the input/output interface and the bus of the management server 7.

In step S83, upon obtaining the bookmark information request signal and device unique ID supplied from the communication unit, the CPU reads out a user ID management table (e.g., the user ID management table illustrated in FIG. 7) stored in the storage unit of the management server 7. In step S84, the CPU refers to the user ID management table read out from the storage unit and extracts bookmark information associated with the mobile terminal 2, on the basis of the device unique ID assigned to the mobile terminal 2 and added to the bookmark information request signal. For example, if the device unique ID “0234567891b” is obtained from the mobile terminal 2, “bookmark information 1” associated with the mobile terminal 2 identified by the device unique ID “01234567891b” is extracted on the basis of this device unique ID. In step S85, the CPU controls the communication unit to transmit the extracted bookmark information to the mobile terminal 2 via the Internet 4.

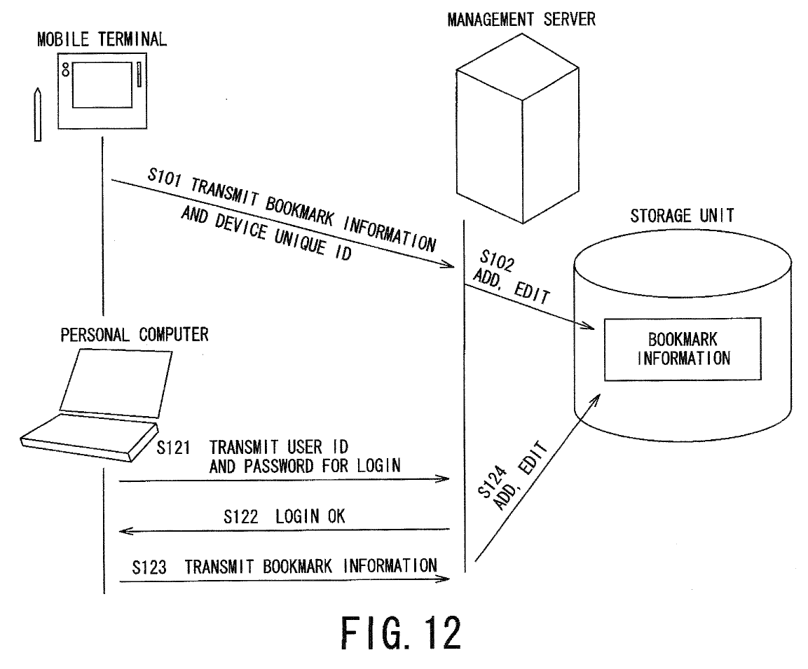

With reference to the flowchart of FIG. 12, an overview of a bookmark information adding/editing process executed between the mobile terminal 2 (see FIG. 2) and the management server 7 (see FIG. 1) or between the management server 7 (see FIG. 1) and the personal computer 8 (see FIG. 1) will be described. Details of the bookmark information adding/editing process will be described later for each device.

For example, if the user connects to the management server 7 from the mobile terminal 2 to add information to or edit bookmark information managed on the management server 7, the mobile terminal 2 executes the browser application in step S101 to connect to a bookmark information adding/editing page on a Web site managed by the management server 7 via the access point 3 and the Internet 4. Then, the mobile terminal 2 transmits adding/editing information related to bookmark information to the management server 7, the adding/editing information being entered by the user on the touch panel 28 by operating the stylus pen 2-a. At the same time, the mobile terminal 2 transmits the device unique ID stored in advance in the storage unit 31 as an environment parameter to the management server 7 via the Internet 4.

In step S102, from the mobile terminal 2, the management server 7 receives the adding/editing information related to the bookmark information and the device unique ID of the mobile terminal 2. On the basis of the received device unique ID, the management server 7 identifies the mobile terminal 2 that has transmitted the adding/editing information related to the bookmark information. Then, on the basis of the received adding/editing information related to the bookmark information, the management server 7 adds information to or edits the current bookmark information registered and associated with the identified mobile terminal 2.

Alternatively, if the user connects to the management server 7 from the personal computer 8 to add information to or edit bookmark information managed on the management server 7, the personal computer 8 connects in step S121 to the bookmark information adding/editing page on the Web site managed by the management server 7 via the access point 3 and the Internet 4. Then, the personal computer 8 transmits a user ID and password to the management server 7 via the Internet 4, the user ID and password being entered by the user on a login screen by operating an input unit of the personal computer 8.

In step S122, the management server 7 receives the user ID and password transmitted from the personal computer 8. On the basis of the received user ID and password, the management server 7 determines whether the user is an authorized user, and identifies the personal computer 8 (or the user who owns the personal computer 8). If it is determined that the user is an authorized user, the management server 7 transmits a “login OK” response (login permission response) to the personal computer 8 via the Internet 4. In step S123, the personal computer 8 transmits adding/editing information related to bookmark information to the management server 7 via the Internet 4, the adding/editing information being entered by the user by operating the input unit. The management server 7 receives the adding/editing information transmitted from the personal computer 8. Then, on the basis of the received adding/editing information related to the bookmark information, the management server 7 adds information to or edits the current bookmark information registered and associated with the identified personal computer 8.

Thus, from either of the mobile terminal 2 and the personal computer 8, the user can add information to or edit the bookmark information managed on the management server 7. Various types of user-specific information such as bookmark information, a history of destinations, and information about a page currently being viewed, managed for each mobile terminal 2 in the management server 7 can be synchronized between the mobile terminal 2 and the personal computer 8. Therefore, it is possible to improve convenience in connecting to Web sites.

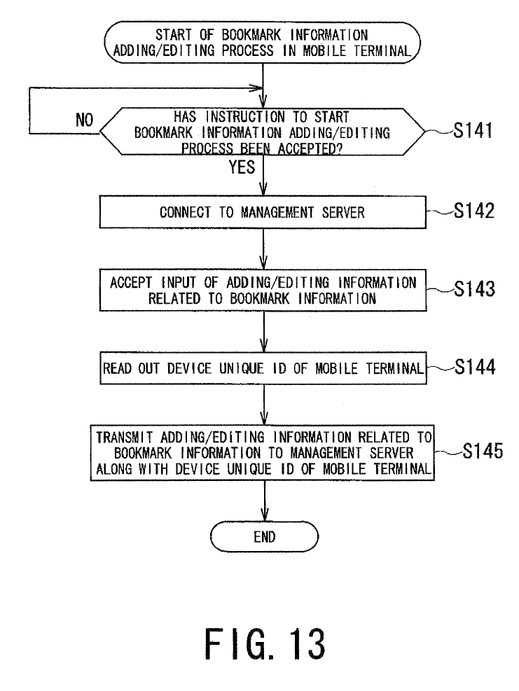

With reference to the flowchart of FIG. 13 a bookmark information adding/editing process in the mobile terminal 2 (see FIG. 2) will be described in detail. In step S141, the CPU 22 of the control unit 21 determines whether an instruction to start the bookmark information adding/editing process has been accepted, the instruction being made by the user by tapping the icon α on the touch panel 28 with the stylus pen 2-a. The CPU 22 waits until it determines that the instruction to start the bookmark information adding/editing process has been accepted. If the CPU 22 determines in step S141 that the instruction to start the bookmark information adding/editing process has been accepted, the process proceeds to step S142. In step S142, the CPU 22 executes the browser application, and connects to the management server 7 via the access point 3 and the Internet 4 on the basis of the URL of the management server 7.

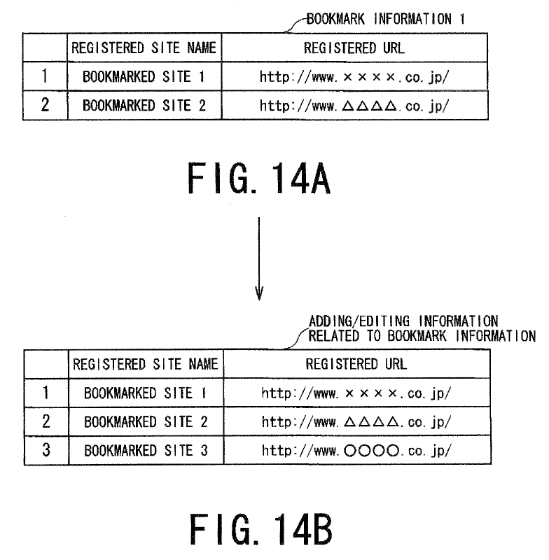

In step S143, the CPU 22 accepts input of adding/editing information related to bookmark information, the input being made by the user on the touch panel 28 by operating the stylus pen 2-a. Specifically, for example, adding/editing information related to bookmark information shown in FIG. 14B is input. The adding/editing information shown in FIG. 14B is obtained by adding “bookmarked site 3” having a URL of “http://www.oooo.co.jp” to the bookmark information 1 shown in FIG. 14A.

In step S144, the CPU 22 reads out the device unique ID uniquely assigned to the mobile terminal 2 and stored in advance in the storage unit 31. In step S145, the CPU 22 controls the communication unit 34 to transmit, to the management server 7 via the Internet 4r the adding/editing information related to bookmark information and the read-out device unique ID added thereto, the adding/editing information for which the input has been accepted in step S143.

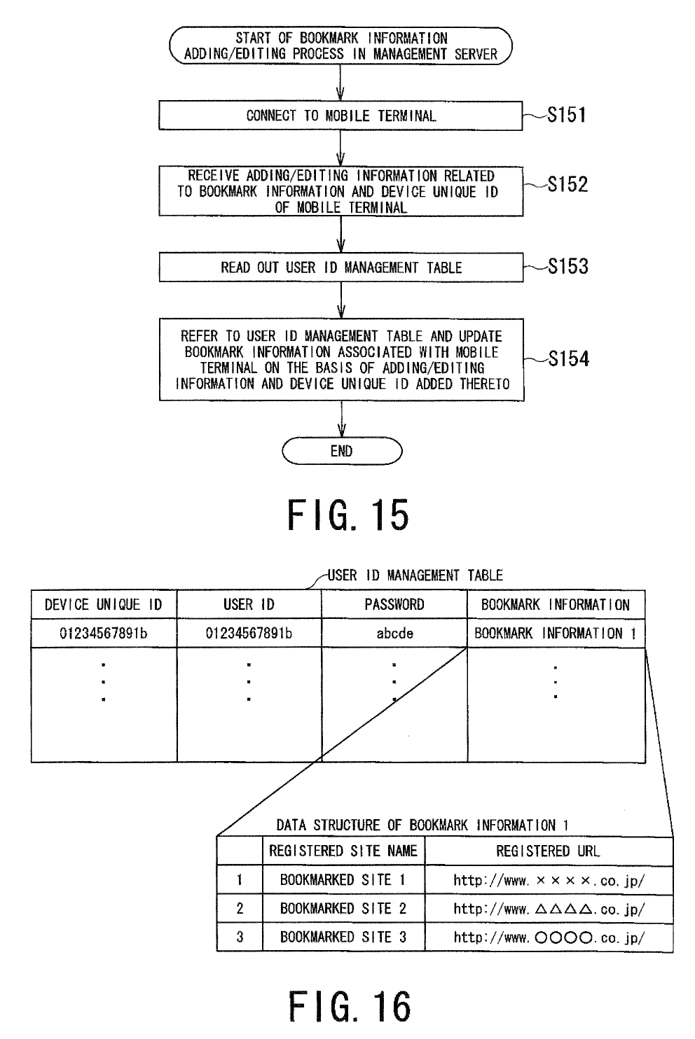

With reference to the flowchart of FIG. 15, a bookmark information adding/editing process performed in the management server 7 (see FIG. 1), which is corresponding to the bookmark information adding/editing process (see FIG. 13) in the mobile terminal 2, will be described in detail. In step S151, upon obtaining a connection request from the mobile terminal 2 via the communication unit, the CPU of the management server 7 controls the communication unit to establish a connection between the management server 7 and the mobile terminal 2 via the Internet 4. In step S152, the communication unit receives, from the mobile terminal 2, adding/editing information related to bookmark information and the device unique ID added thereto. The communication unit supplies the received adding/editing information related to bookmark information and device unique ID to the CPU via the input/output interface and the bus of the management server 7.

In step S153, upon obtaining the adding/editing information related to bookmark information and device unique ID supplied from the communication unit, the CPU reads out a user ID management table (e.g., the user ID management table illustrated in FIG. 7) stored in the storage unit of the management server 7. In step S154, the CPU refers to the user ID management table read out from the storage unit and updates the bookmark information 1 associated with the mobile terminal 2, on the basis of the adding/editing information related to bookmark information and the device unique ID added thereto. For example, the data structure of the bookmark information 1 shown in FIG. 7 is updated to data structure shown in FIG. 16. The bookmark information 1 shown in FIG. 16 is obtained by adding “bookmarked site 3” having a URL of “http://www.oooo.co.jp” to the bookmark information 1 shown in FIG. 7.

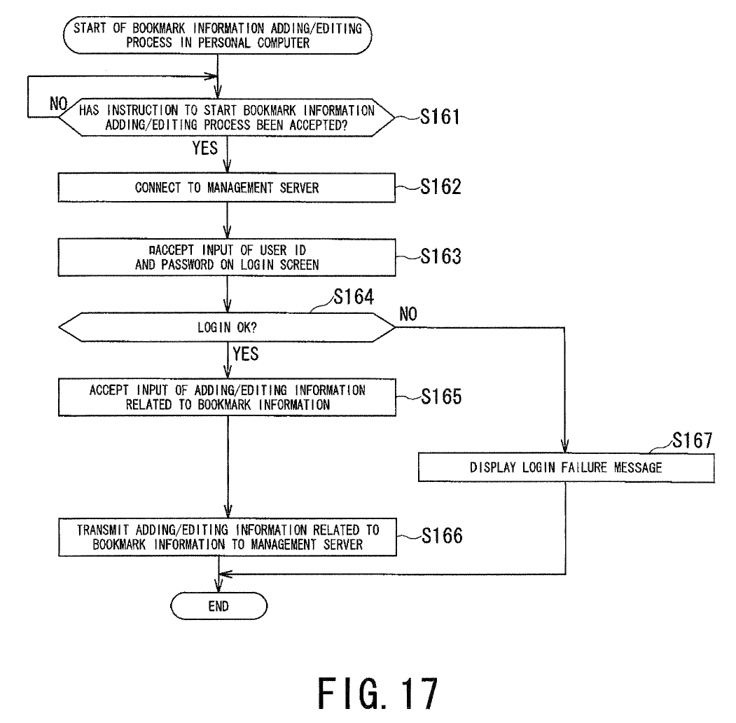

With reference to the flowchart of FIG. 17, a bookmark information adding/editing process in the personal computer 8 (see FIG. 1) will be described in detail. The personal computer 8 has a CPU, a ROM, a RAM, a bus, an input/output interface, an input unit, an output unit, a storage unit and a communication unit. In step S161, the CPU of the personal computer 8 determines whether an instruction to start the bookmark information adding/editing process has been accepted, the instruction being made by the user by operating the input unit of the personal computer 8. The CPU waits until it determines that the instruction to start the bookmark information adding/editing process has been accepted. If the CPU determines in step S161 that the instruction to start the bookmark information adding/editing process has been accepted, the process proceeds to step S162. In step S162, the CPU controls a communication unit of the personal computer 8 to connect to the management server 7 via the Internet 4. In step S163, the CPU accepts input of a user ID and password own a login screen displayed by an output unit of the personal computer 8. For example, the CPU accepts input of a user ID “01234567891b” and password “abcde”.

In step S164, the CPU determines whether the login is OK, on the basis of a login response received from the management server 7 via the communication unit. If the CPU determines in step S164 that the login is not OK, the process proceeds to step S167. In step S167, the CPU controls the output unit to display a login failure message indicating that the login fails. On the other hands if the CPU determines in step S164 that the login is OK, the process proceeds to step S165. In step S165, the CPU accepts input of adding/editing information related to bookmark information, the input being made by the user by operating the input unit. Details of the adding/editing information related to bookmark information are basically the same as those shown in FIG. 14B.

In step S166, the CPU controls the communication unit to transmit the adding/editing information related to bookmark information to the management server 7 via the Internet 4, the adding/editing information whose input has been accepted.

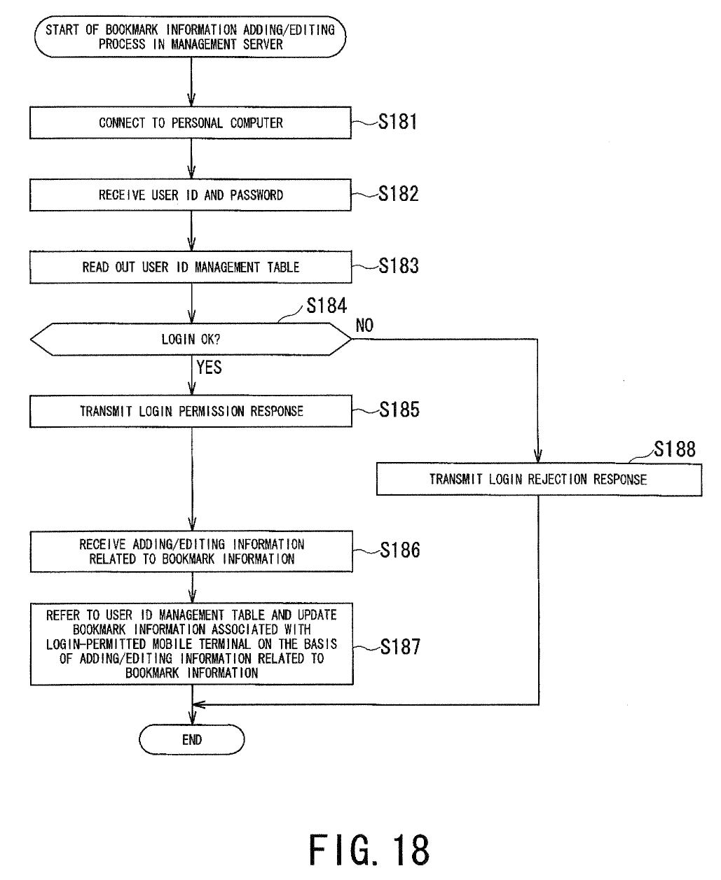

With reference to the flowchart of FIG. 18, a bookmark information adding/editing process performed in the management server 7 (see FIG. 1), which is corresponding to the bookmark information adding/editing process (see FIG. 17) in the personal computer 8, will be described in detail. In step S181, upon obtaining a connection request from the personal computer 8 via the communication unit, the CPU controls the communication unit to establish a connection between the management server 7 and the personal computer 8 via the Internet 4. In step S182, the communication unit receives a user ID and password transmitted from the personal computer 8. The communication unit supplies the received user ID and password to the CPU via the input/output interface and the bus of the management server 7.

In step S183, upon obtaining the user ID and password supplied from the communication unit, the CPU reads out a user ID management table stored in the storage unit of the management server 7. In step S184, on the basis of the received user ID and password, the CPU determines whether the user is an authorized user, and identifies the mobile terminal 2 owned by the user who has connected to the management server 7 from the personal computer 8. If it is determined in step S184 that the user is an authorized user, the CPU generates a “login OK” response (login permission response). If it is determined in step S184 that the user is not an authorized user, the CPU generates a “login failure” response (login rejection response).

Specifically, for example, the CPU refers to the user ID management table shown in FIG. 7 to recognize the user identified by the received user ID. The CPU then determines whether the received password matches the password associated with the user ID in the user ID management table. In the example of FIG. 7, the password “abcde” is associated with the user ID “01234567891b”. Therefore, if the received password is different from the password “abcde”, the CPU determines that the user is not an authorized user. If the received user ID itself does not exist in the user ID management table, the CPU also determines that the user is not an authorized user.

Referring back to FIG. 18, if the CPU determines in step S184 that the login is not OK, the process proceeds to step S188. In step S188, the CPU controls the communication unit to transmit the login resection response to the personal computer 8 via the Internet 4. On the other hand, if the CPU determines in step S184 that the login is OK, the process proceeds to step S185. In step S185, the CPU controls the communication unit to transmit the login permission response to the personal computer 8 via the Internet 4. In step S186, the communication unit receives the adding/editing information related to bookmark information, the adding/editing information being transmitted from the personal computer 8. The communication unit supplies the received adding/editing information to the CPU via the input/output interface and the bus. In step S187, the CPU refers to the user ID management table read out from the storage unit. Then, on the basis of the adding/editing information related to bookmark information, the CPU updates the bookmark information 1 associated with the mobile terminal 2 (i.e., the mobile terminal 2 owned by the user who has connected to the management server 7 from the personal computer 8) for which login is permitted. For example, the data structure of the bookmark information 1 shown in FIG. 7 is updated to data structure shown in FIG. 16. The bookmark information 1 shown in FIG. 16 is obtained by adding “bookmarked site 3” having a URL of “http://www.oooo.co.jp” to the bookmark information 1 shown in FIG. 7.

In the present embodiment, the mobile terminal 2 stores device identification information (device unique ID) for identifying the mobile terminal 2; connects to the management server 7 managing, for each mobile terminal 2, attribute information about one or more content servers 5-1 to 5-n to which the mobile terminal 2 is connected via a network (Internet 4); transmits an attribute information request signal and the device identification information to the management server 7; receives one or more pieces of attribute information from the management server 7; and displays the received one or more pieces of attribute information. Additionally, on the basis of one of the displayed pieces of attribute information, the one for which selection has been accepted, the mobile terminal 2 connects to a content server indicated by the attribute information.

On the other hand, the management server 7 receives the device identification information from the mobile terminal 2; identifies the mobile terminal 2 on the basis of the received device identification information; issues user identification information (user ID) for identifying a user who owns the mobile terminal 2 and authentication information (password) for determining whether the user is an authorized user; associates the device identification information with the issued user identification information and authentication information, and stores them in a user ID management table; reads out the user ID management table upon receipt of the attribute information request (bookmark information request) from the mobile terminal 2; refers to the read-out user ID management table; extracts attribute information associated with the mobile terminal 2, on the basis of the device identification information added to the attribute information request; and transmits the extracted attribute information to the mobile terminal 2.

Thus, for connection to the management server 7 from the mobile terminal 2, the user does not have to use a user ID and password and can connect to the management server 7 without regard to the presence of the user ID and password. Therefore, it is possible to reduce the number of user actions on the mobile terminal 2 and improve convenience in connecting to Web sites. In particular, the user ID for the mobile terminal 2 is properly managed. Thus, various types of user-specific information (e.g., bookmark information, history of destinations, and information about a page currently being viewed) managed for each mobile terminal 2 by the management server 7 can be synchronized between the mobile terminal 2 and the personal computer 8.

As described above, a device unique ID (e.g., serial number or MAC address) of the mobile terminal 2 is used for managing the user ID. The device unique ID is a unique number assigned before shipment of the mobile terminal 2, and cannot be changed by the user after purchase of the mobile terminal 2. For connecting to the management server 7 to obtain bookmark information therefrom, the device unique ID is automatically transmitted to the management server 7. Therefore, even when no authentication process involving password authentication is performed, security is maintained to a sufficient level.

Even when the USB wireless LAN communication unit 34-2 is removable from the mobile terminal 2 via the card slot I/F 32 or USB connector 33, since the device unique ID (e.g., serial number or MAC address) of the mobile terminal 2 is used to manage the user ID, it is possible to suitably manage the user ID for the mobile terminal 2 having the USB wireless LAN communication unit 34-2 which is not a built-in component.

### Second Embodiment

When using a portal site to frequently connect to various Web sites from the mobile terminal 2, the user may save URLs and names of accessed Web sites in the mobile terminal 2 to efficiently use various kinds of information managed on the Web sites. However, this may still cause inconvenience to the user in connecting to Web sites. Therefore, for example, site-related information may be combined with a calendar function, associated with a date and time of connection, and called as a page memo, as desired by the user. Thus, convenience in frequently connecting to various Web sites can be improved.

Hereinafter, a second embodiment of the present invention will be described. The configurations of the network system 1 and mobile terminal 2 of the second embodiment are basically the same as those of the first embodiment, and thus will not be described here. In the first embodiment, the mobile terminal 2 connects to Web sites via the relay server 6. However, the second embodiment is applicable also to the case where the relay server 6 is bypassed.

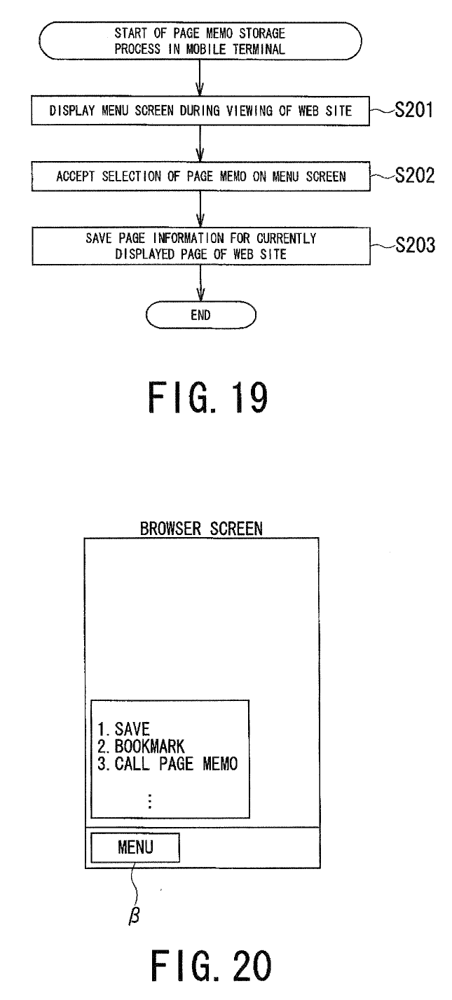

With reference to the flowchart of FIG. 19, a page memo storage process in the mobile terminal 2 (see FIG. 2) will be described. The page memo storage process is executed while a browser screen, such as that illustrated in FIG. 20, is being displayed on the display unit 30 and any Web site is being viewed.

In step S201 of FIG. 19, the CPU 22 controls the display unit 30 to display a menu screen when a menu icon β is tapped on the touch panel 28 by the user with the stylus pen 2-a during viewing of a predetermined Web site. In step S202, the CPU 22 accepts selection of a page memo on the menu screen displayed on the display unit 30, the selection being made by the user by tapping the touch panel 28 with the stylus pen 2-a. In step S203, the CPU 22 saves (stores) page information (e.g., HTML syntax, image data, and Web site name and URL) for a currently displayed page of the Web site in the storage unit 31. Here, the CPU 22 associates and stores the page information with a date and time of execution of a page memo.

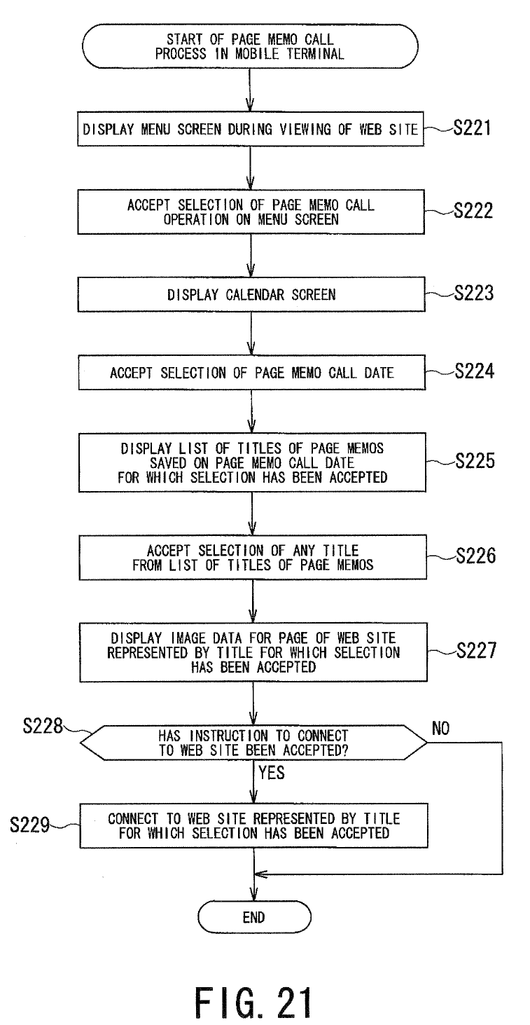

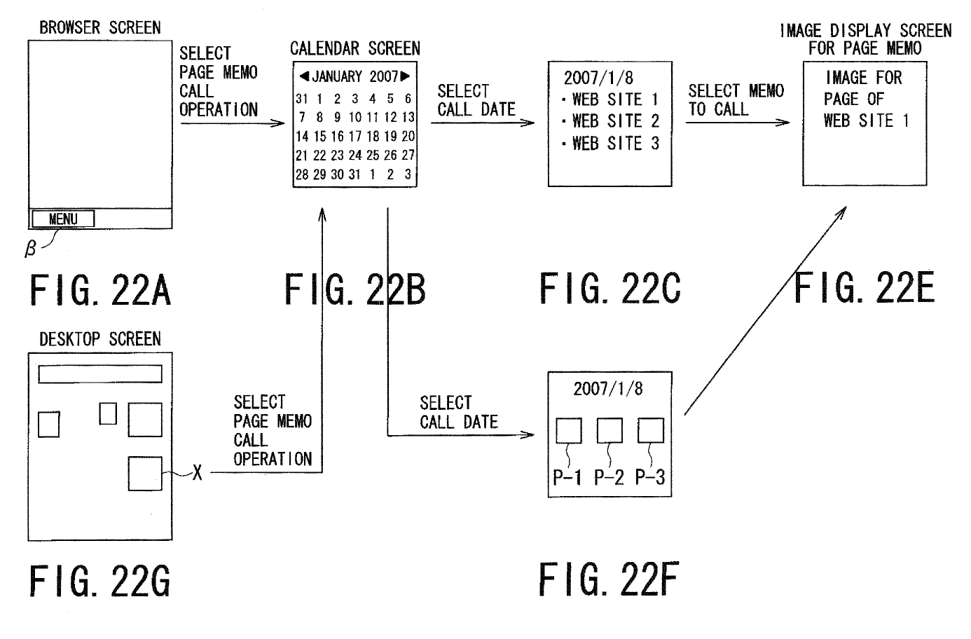

With reference to the flowchart of FIG. 21, a page memo call process in the mobile terminal 2 (see FIG. 2) will be described. In step S221, the CPU 22 controls the display unit 30 to display a menu screen when the menu icon β is tapped on the touch panel 28 by the user with the stylus pen 2-a during viewing of a predetermined Web site, such as that illustrated in FIG. 22A. In step S222, the CPU 22 accepts selection of a page memo call operation on the menu screen displayed on the display unit 30, the selection being made by the user by tapping the touch panel 28 with the stylus pen 2-a.

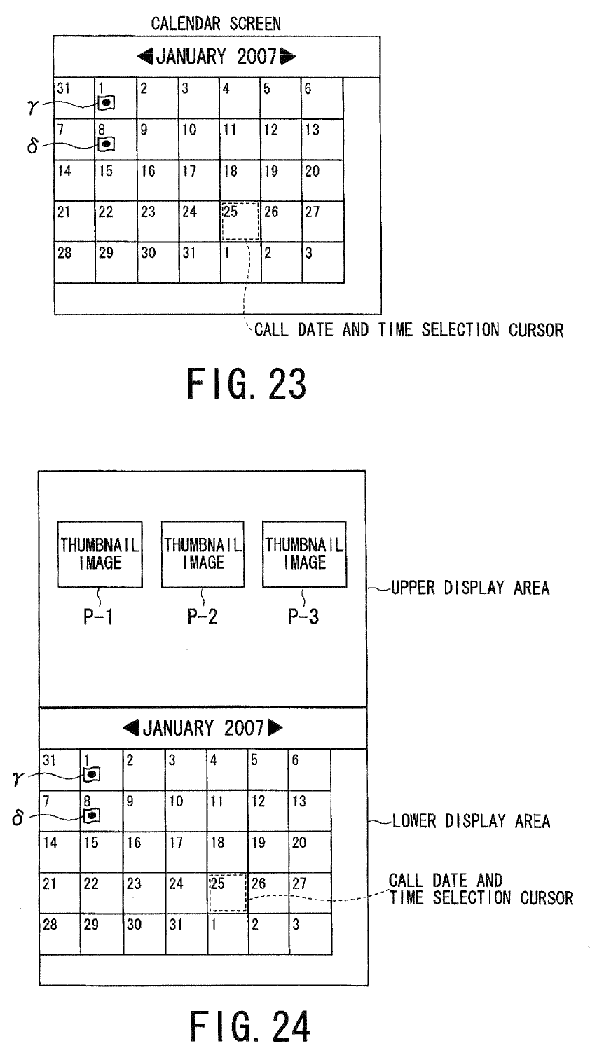

In step S223, the CPU 22 controls the display unit 30 to display a calendar screen. In accordance with the control of the CPU 22, the display unit 30 displays a calendar screen, such as that illustrated in FIG. 22B. In a display area corresponding to a date and time at which a page memo was stored by the page memo storage process described with reference to the flowchart of FIG. 19, an indication indicating that a page memo is stored is superimposed on the calendar screen. FIG. 23 is an enlarged view of the calendar screen illustrated in FIG. 22B. As illustrated in FIG. 23, in display areas corresponding to respective dates (e.g., Jan. 1 and 8, 2007) on which page memos were stored by the page memo storage process described above, icons γ and δ each indicating that a page memo is stored (saved) are superimposed on the calendar screen. This informs the user that there are saved page memos about Web sites accessed on the dates indicated by the icons γ and δ.

In step S224 of FIG. 21, the CPU 22 accepts selection of a call date and time on the calendar screen displayed on the display unit 30, the selection being made by the user by tapping the touch panel 28 with the stylus pen 2-a. For example, selection of “Jan. 8, 2007” shown in FIG. 23 is accepted. A call date and time selection cursor is superimposed on a display area corresponding to a call date and time which is currently a candidate for selection. In step S225, the CPU 22 controls the display unit 30 to display a list of titles of page memos saved on the date and time for which the selection has been accepted. In accordance with the control of the CPU 22, the display unit 30 displays, as illustrated in FIG. 22C, a list of titles of page memos saved on the date and time for which the selection has been accepted. In the example of FIG. 22C, Web site names (page memo titles) “Web site 1” to “Web site 3”, are displayed as a list of titles of page memos saved on Jan. 8, 2007.

In step S226, the CPU 22 accepts selection of any title on the list of page memo titles displayed on the display unit 30, the selection being made by the user by tapping the touch panel 28 with the stylus pen 2-a. In the example of FIG. 22C selection of the title “Web site 1” is accepted. In step S227, the CPU 22 controls the display unit 30 to display image data for a page of a Web site represented by the title for which the selection has been accepted. In accordance with the control of the CPU 22, the display unit 30 displays, as illustrated in FIG. 22E, image data for a page of a Web site represented by the title for which the selection has been accepted. This allows the user to immediately view the content of the page memo saved on Jan. 6, 2007.

In step S228, the CPU 22 determines whether an instruction to connect to the displayed Web site has been accepted, the instruction being made by the user by tapping the touch panel 28 with the stylus pen 2-a. If the CPU 22 determines in step S228 that the instruction to connect to the displayed Web site has been accepted, the process proceeds to step S229. In step S229, the CPU 22 controls the communication unit 34 to start connecting to this Web site, on the basis of the URL of the Web site represented by the title for which the selection has been accepted in step S226. If the Web site based on this URL is updated, the updated Web site is displayed upon connection.

If the CPU 22 determines in step S228 that the instruction to connect to the displayed Web site has not been accepted, the process skips step S229.

In step S225 described above, a list of titles of page memos is displayed as illustrated in FIG. 22C. Alternatively, as illustrated in FIG. 22F, thumbnail images P-1 to P-3 for page memos stored on the date and time for which the selection has been accepted in step S224 may be displayed in step S225.

Before selection of a call date and time is accepted in step S224, when the call date and time is highlighted by the call date and time selection cursor, the display screen of the display unit 30 may be split into two areas, for example, an upper display area and a lower display area, as illustrated in FIG. 24. The display unit 30 may display, in the upper display area, the thumbnail images P-1 to P-3 for page memos stored on the date and time highlighted by the call date and time selection cursor, and the display unit 30 may display, in the lower display area, a calendar screen. Alternatively, the thumbnail images P-1 to P-3 may be displayed within the field of the corresponding date and time.

In the foregoing description, a page memo call operation is performed from the browser screen (see, e.g., FIG. 22A) on which a predetermined Web site is being viewed. Alternatively, as illustrated in FIG. 22G, a page memo call operation may be performed directly from a desktop screen by tapping a dedicated icon X for calling page memos.

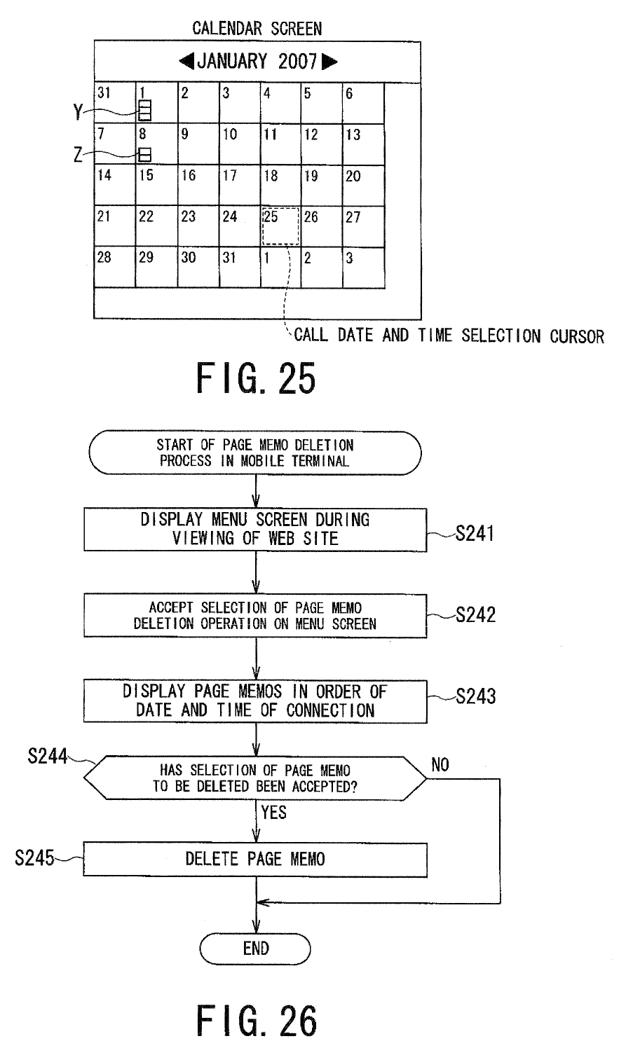

As illustrated in FIG. 25, icons Y and Z, each indicating the number of stored (saved) page memos, may be superimposed on display areas corresponding to respective dates (e.g., Jan. 1 and 8, 2007) on which page memos were stored by the page memo storage process described above. The icon Y indicates that the number of page memos stored on Jan. 1, 2007 is three, while the icon Z indicates that the number of page memos stored on Jan. 8, 2007 is two.

In the foregoing description, a calendar screen is used to present page memos. Alternatively, a plurality of pieces of destination information, such as page memos, may be displayed as a history list, for example, in order of date and time of connection. The display format may be switched between “calendar” and “history list” with a tab. Thus, user's convenience in viewing page memos is improved.

If the user frequently connects to various Web sites and frequently saves page memos about such Web sites, the memory area of the storage unit 31 may become full. Therefore, a page memo deletion process for deleting saved page memos may be executed as necessary. Hereinafter, a page memo deletion process will be described.

With reference to the flowchart of FIG. 26, a page memo deletion process in the mobile terminal 2 (see FIG. 2) will be described. In step S241, the CPU 22 controls the display unit 30 to display a menu screen when the menu icon β is tapped on the touch panel 28 by the user with the stylus pen 2-a during viewing of a predetermined Web site, such as that illustrated in FIG. 22A. In step S242, the CPU 22 accepts selection of a page memo deletion operation on the menu screen displayed on the display unit 30, the selection being made by the user by tapping the touch panel 28 with the stylus pen 2-a.

In step S243, the CPU 22 controls the display unit 30 to display stored page memos in order of date and time of connection. The display unit 30 displays the stored page memos in order of date and time of connection to their corresponding Web sites. In step S244, the CPU 22 determines whether selection of a page memo to be deleted has been accepted, the selection being made by the user by tapping the touch panel 28 with the stylus pen 2-a. If the CPU 22 determines in step S244 that the selection of a page memo to be deleted has been accepted, the process proceeds to step S245. In step S245, the CPU 22 executes deletion of the page memo for which the selection has been accepted. On the other hand, if the CPU 22 determines in step S244 that the selection of a page memo to be deleted has not been accepted, the process skips step S245 and ends without executing the page memo deletion.

Thus, page memos can be deleted in order of date and time of connection, that is, in order of increasing priority. The date and time of connection to a page memo that is frequently viewed is updated to the latest date and time of connection. Thus, without regard to the date and time of storage at which the page memo was stored, deletion of the page memo can be executed on the basis of the latest date and time of connection (i.e., the latest order of priority).

The present invention is applicable also to personal digital assistants (PDAs), personal computers, mobile game machines, mobile music players, mobile video players, and other types of mobile terminals.

The series of processes described in the embodiments of the present invention may be executed either by software or hardware.

In the embodiments of the present invention, steps in each flow are processed sequentially in the described order. However, these steps may not necessarily be processed sequentially, but may be processed simultaneously or individually.

What is claimed is:

1. A mobile terminal being capable of connecting a destination terminal via a network and being capable of connecting to a management server managing attribute information related to at least one the destination terminal, comprising:
a storage unit configured to store device identification information for identifying the mobile terminal;
a first connecting unit configured to connect to the management server;
a transmitting unit configured to transmit, to the management server, the device identification information and a request signal for obtaining the attribute information;
a receiving unit configured to receive the attribute information from the management server; and
a display unit configured to display data based on the attribute information received by the receiving unit.

2. The mobile terminal according to claim 1, further comprising a second connecting unit configured to connect to the destination terminal indicated by any attribute information for which selection is accepted from among a plurality of pieces of attribute information displayed by the display unit.

3. The mobile terminal according to claim 1, wherein the attribute information includes at least an URL related to the destination terminal.

4. The mobile terminal according to claim 1, wherein the attribute information is managed each mobile terminal by the management server.

5. The mobile terminal according to claim 1, wherein the device identification information is unmodifiable.

6. The mobile terminal according to claim 1, wherein the transmitting unit transmits the device identification information to the management server if use registration for managing the attribute information in the management server is performed;
the receiving unit receives user identification information and authentication information, the user identification information being used for identifying a user who owns the mobile terminal, the authentication information being used for determining whether the user is an authorized user; and
the display unit displays the user identification information and the authentication information received by the receiving unit.

7. The mobile terminal according to claim 1, wherein if the mobile terminal adds information to or editing the attribute information managed on the management server the transmitting unit transmits, to the management server, the device identification information and adding/editing information related to the attribute information.

8. A mobile terminal being capable of connecting a destination terminal via a network, comprising:
a storage unit configured to store image data obtained from at least one the destination terminal, information related to a date and time of connection to the destination terminal, and attribute information related to the destination terminal; and
a display unit configured to display indication information in a display area on a screen displaying a list of dates, the indication information indicating that the image data, the information related to the date and time of connection to the destination terminal, and the attribute information are stored by the storage unit, the display area corresponding to the stored date and time of connection to the destination terminal.

9. The mobile terminal according to claim 8, wherein the display unit displays the indication information in respective display areas corresponding to the stored date and time of connection to the destination terminal.

10. The mobile terminal according to claim 8, wherein the display unit superimposes a display of the indication information onto the display area corresponding to the stored date and time of connection to the destination terminal.

11. The mobile terminal according to claim 8, wherein the display unit displays at least the attribute information related to the destination terminal if the display area in which the indication information is displayed is selected on the screen displaying the list of dates.

12. The mobile terminal according to claim 11, further comprising a connecting unit configured to connect to the destination terminal on the basis of the attribute information related to the destination terminal, the attribute information being displayed by the display unit.

13. The mobile terminal according to claim 11, wherein the attribute information includes at least a name related to the destination terminal.

14. The mobile terminal according to claim 8, wherein the display unit displays thumbnail image based on the image data if the display area in which the indication information is displayed is selected on the screen displaying the list of dates.

15. The mobile terminal according to claim 14, wherein the display unit displays a list of dates in a first display area and the thumbnail image in a second display area.

16. The mobile terminal according to claim 14, wherein the display unit displays, in the display area corresponding to the stored date and time of connection to the destination terminal, a number of the destination terminal stored by the storage unit.

17. The mobile terminal according to claim 8, further comprising a deleting unit configured to delete the image data, the information related to the date and time of connection to the destination terminal, and the attribute information which are store by the storage unit.
